(19) United States
(12) Patent Application Publication
(10) Pub. No.: US 2015/0156732 A1
(43) Pub. Date: Jun. 4, 2015

(54) METHOD, APPARATUS AND SYSTEM FOR CONTROLLING POWER OF WIRELESS COMMUNICATION DEVICE

(71) Applicant: INTEL CORPORATION, Santa Clara, CA (US)

(72) Inventors: Solomon B. Trainin, Haifa (IL); Ran Mor, Herzlia (IL)

(21) Appl. No.: 14/557,693

(22) Filed: Dec. 2, 2014

Related U.S. Application Data
(63) Continuation of application No. 13/161,521, filed on Jun. 16, 2011.
(60) Provisional application No. 61/433,292, filed on Jan. 17, 2011.

(51) Int. Cl. H04W 52/24; H04W 24/08

(52) U.S. Cl. CPC H04W 52/248; H04W 24/08

(57) ABSTRACT

Devices, systems and methods of controlling transmit power of a station are disclosed. The station is able to request for link management, to receive a response frame with an indication to decrease and/or to increase the transmit power and, if the transmit power is increased or decreased no later than a predefined time interval, the station sends a link adaptation acknowledgment with an indication to increase or decrease the transmit power.

### CROSS REFERENCE TO RELATED APPLICATIONS

This Application is a Continuation Application of U.S. patent application Ser. No. 13/161,521, Filed on Jun. 16, 2011, which in turn claims the benefit of, and priority from, U.S. Provisional Patent Application 61/433,292, filed on Jan. 17, 2011 (and entitled “Method Apparatus and System For Controlling Power of Wireless Communication Device”), the entire disclosures of which are incorporated herein by reference.

### BACKGROUND OF THE INVENTION

A personal wireless area network (WPAN) is a network used for communication among computing devices (for example, personal devices such as telephones and personal digital assistants) close to one person. The reach of a WPAN may be a few meters. WPANs may be used for interpersonal communication among personal devices themselves, or for connecting via an uplink to a higher level network, for example, the Internet.

The millimeter-wave WPAN and/or mmWave network may allow very high data rates (e.g., over 2 Gigabit per second (Gbps)) applications such as high speed Internet access, streaming content download (e.g., video on demand, high-definition television (HDTV), home theater, etc.), real time streaming and wireless data bus for cable replacement.

Some mmWave WPAN may include a personal basic service set (PBSS). The PBSS may include a plurality of stations (STA). The STAs may be multi-band capable STAs and/or 60 GHz STAs, which are also referred hereinbelow as DBand stations. The mmWave WPAN may also allow one of the STAs to be capable of operating as, and/or performing as, a PBSS control point (PCP).

Transmission Power Control (TPC) is a function for managing the operation of the PBSS. It may happen that a receiving station may be so close to a transmitting station, such that a receiver amplifier of the receiving station may be saturated for the data transmission. Antenna selection in a direct WPAN system may be accomplished by a direct band (DBand) Beamforming procedure, wherein the Beamforming procedure may include a sector level sweep (SLS) and Beamforming refinement procedures. DBand STAs exchange antenna identifications (IDs) information for an antenna configuration. The TPC procedure may allow to indicate an increase and/or decrease in the transmit Power. However more parameters may be provided by the TPC in order to control the transmit power of the stations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication network according to exemplary embodiments of the present invention;

FIG. 2 is a schematic illustration of a DBand station link adaptation Acknowledgment information element according to one exemplary embodiment of the invention.

FIG. 3 is a schematic illustration of a system including a station of a wireless communication network according to exemplary embodiments of the present invention; and

FIG. 4 is a flow chart of a method of controlling a transmitting power, according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, or transmission devices. The terms “a” or “an”, as used herein, are defined as one, or more than one. The term plurality, as used herein, is defined as two, or more than two. The term another, as used herein, is defined as, at least a second or more. The terms including and/or having, as used herein, are defined as, but not limited to, comprising. The term coupled as used herein, is defined as operably connected in any desired form for example, mechanically, electronically, digitally, directly, by software, by hardware and the like.

The term PBSS control point (PCP) as used herein with embodiments of the invention, is defined as a station (STA) that operates as a control point of the mmWave network.

The term access point (AP) as used herein with embodiments of the invention, is defined as any entity that has STA functionality and provides access to the distribution services, via the wireless medium (WM) for associated STAs.

The term wireless network controller as used herein with embodiments of the invention, is defined as a station that's operates as PCP and/or as AP of the wireless network.

The term directional band (DBand) as used herein with embodiments of the invention, is defined as any frequency band wherein the Channel starting frequency is above 45 GHz.

The term DBand STA as used herein with embodiments of the invention, is defined as a STA whose radio transmitter is operating on a channel that is within the DBand.

The term personal basic service set (PBSS) as used herein with embodiments of the invention, is defined as a basic service set (BSS) which forms an ad hoc self-contained network, operates in the DBand, includes one PBSS control point (PCP), and in which access to a distribution system (DS) is not present but an intra-PBSS forwarding service is optionally present.

The term scheduled service period (SP) as used herein with embodiments of the invention, is scheduled by a quality of service (QoS) AP or a PCP. Scheduled SPs may start at fixed intervals of time, if desired.

The terms “traffic” and/or “traffic stream(s)” as used herein with embodiments of the invention, are defined as a data flow and/or stream between wireless devices such as STAs.

The term “session” as used herein with embodiments of the invention, is defined as state information kept or stored in a pair of stations that have an established a direct physical link (e.g., excludes forwarding); the state information may describe or define the session.

The term “wireless device” as used herein with embodiments of the invention includes, for example, a device capable of wireless communication, a communication device capable of wireless communication, a communication station capable of wireless communication, a portable or non-portable device capable of wireless communication, or the like. In some embodiments, a wireless device may be or may include a peripheral device that is integrated with a computer, or a peripheral device that is attached to a computer. In some embodiments, the term “wireless device” may optionally include a wireless service.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, WLAN stations, wireless personal network (WPAN), and the like.

Types of WPAN stations intended to be within the scope of the present invention include, although are not limited to, stations capable of operating as a multi-band stations, stations capable of operating as PCP, stations capable of operating as an AP, stations capable of operating as DBand stations, mobile stations, access points, stations for receiving and transmitting spread spectrum signals such as, for example, Frequency Hopping Spread Spectrum (FHSS), Direct Sequence Spread Spectrum (DS SS), Complementary Code Keying (CCK), Orthogonal Frequency-Division Multiplexing (OFDM) and the like.

Some embodiments may be used in conjunction with various devices and systems, for example, a docking station of a laptop computer, a network interface card (NIC), a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a display, a flat panel display, a Personal Media Player (PMP), a digital video camera (DVC), a digital audio player, a speaker, an audio receiver, an audio amplifier, a data source, a data sink, a Digital Still camera (DSC), a Personal Computer (PC), a desktop computer, a mobile computer, a laptop computer, a notebook computer, a tablet computer, a server computer, a handheld computer, a smart phone, a touch phone, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless AP, a wired or wireless router, a wired or wireless modem, a wired or wireless network, a wireless area network, a Wireless Video Are Network (WVAN), a Local Area Network (LAN), a WLAN, a PAN, a WPAN, devices and/or networks operating in accordance with existing WirelessHD™ and/or Wireless-Gigabit-Alliance (WGA) specifications and/or future versions and/or derivatives thereof, devices and/or networks operating in accordance with existing IEEE 802.11 (IEEE 802.11-19992007: Wireless LAN Medium Access Control (MAC) and Physical Layer (PHY) Specifications) standards and amendments (“the IEEE 802.11 standards”), IEEE 802.16 standards, and/or future versions and/or derivatives thereof.

Units and/or devices which are part of the above networks, one way and/or two-way radio communication systems, cellular radio-telephone communication systems, Wireless-Display (WiDi) device, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, 4.5G Enhanced Data rates for GSM Evolution (EDGE), or the like. Other embodiments may be used in various other devices, systems and/or networks.

Some embodiments may be used in conjunction with suitable limited-range or short-range wireless communication networks, for example, “piconets”, e.g., a wireless area network, a WVAN, a WPAN, and the like.

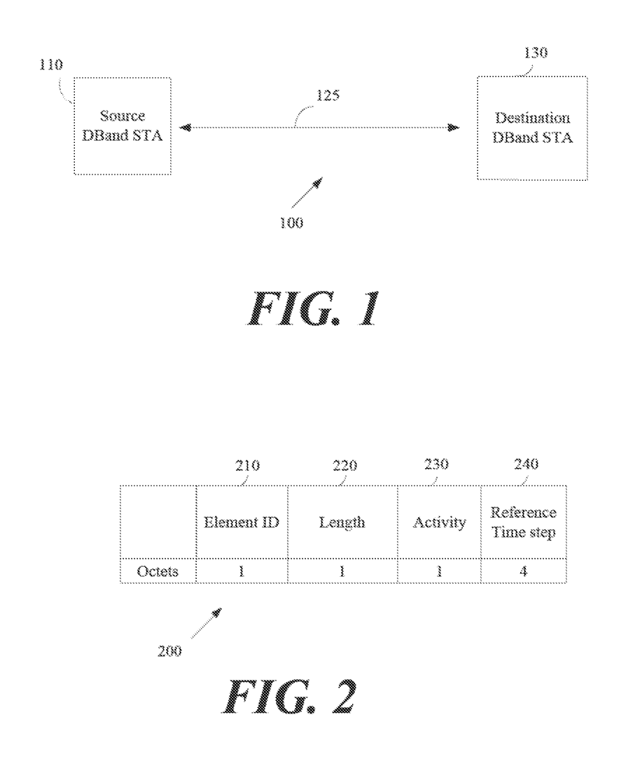

Turning first to FIG. 1, a schematic illustration of a wireless communication network 100 according to exemplary embodiments of the present invention is shown. For example, wireless communication network 100 may operate according to the standard developed by the IEEE 802 802.11 Task Group ad (TGad) and/or according to WGA specification and/or according to IEEE 802.15.3c standard and/or according to WirelessHD™ specification and/or ECMA-387 standard or other suitable wireless standard for communication in the 60 GHz frequency band (e.g., DBand).

Although the scope of the present invention is not so limited, wireless communication network 100 may include a station 110 and a station 130. For example, in the WGA and IEEE802.11ad stations 110 are referred as DBand stations. According to this exemplary embodiment, each of stations 110 and 130 may be capable of controlling the transmit power of each station by using a protocol element such as, for example, a transmit power control (TPC) operation, if desired.

Furthermore, station 110 and station 130 may be capable of operating as source and/or destination DBand stations, respectively, although the scope of the present invention is not limited in this respect.

According to some exemplary embodiments of the invention, stations 110 and 130 may perform a direct link communication over a wireless link 125. Station 110 may ask station 130 to change its transmission power, if desired. Stations 110 and 130 may include multiple antenna elements (e.g., a phase array antenna). A beamforming (BF) algorithm may be used to determine an optimal antenna configuration for exchanging data between stations 110 and 130. For example, station 110 may use a link measurement procedure to measure a link quality of wireless link 125, if desired. According to embodiments of the invention, wireless link 125 is a directional wireless link at 60 Ghz frequency band. Station 110 may insert the link quality information in a DBand Link Margin information element, if desired. The DBand Link Margin information element may provide means for adjusting TPC for plurality of antenna elements of a desirable antenna configuration of station 130, although the scope of the present invention is not limited in this respect.

In some others embodiments of the invention, the TPC may also be achieved via selection of a subset of antennas using BF, although the scope of the present invention is not limited to this example. According to some exemplary embodiments of the invention, the TPC protocol may include Link Measurement Request and Response frames. The Link Measurement Request and Response frames may be used to obtain Link Margin information. The Link Margin information may include receive signal strength information (RSSI) or any other link quality measurement know in the art which may use to determine appropriate action by a requesting STA.

Furthermore, according to embodiments of the invention, the TPC protocol and/or procedure may include a request frame and a report frame, if desired. For example, the repot frame may be a link measurement report frame as defined by the WGA standard and IEEE802.11ad standard. The link measurement report format is shown with table 1 below.

TABLE 1
Link Measurement Report frame format

| Subelement | | Length field | |
|---|---|---|---|
| ID | Name | (octets) | Extensible |
| 162 | DBand Link Margin | 8 | |
| 172 | DBand Link Adaptation | 5 | Extensible |
| | Acknowledgement | | |

A STA receiving (e.g., Station 130) the request frame may respond with the report frame over wireless link 125. For example, the report frame may include a power value used to transmit the response, if desired.

For example, the report frame may include the power value in a Transmit Power field of the request frame and the estimated link margin value in a Link Margin field of the request frame, although it should be understood the scope of the present invention is not limited to this example.

Turning to FIG. 2, a DBand station link adaptation Acknowledgment information element 200 according to one exemplary embodiment of the invention is shown. According to some exemplary embodiments, DBand Link Adaptation Acknowledgement element 200 is designed to carry in the sub-elements field of the Link Measurement report frame, if desired.

According to embodiments of the invention, which relate to WGA and/or IEEE 802.11ad standards, DBand station link adaptation Acknowledgment information element 200 may include, at least, but not limited to, an Element field 210, a Length filed 220, a Reference time step field 240 and some other fields may be added.

For example, the information provided by Activity field 230 may be set to the action that the STA (e.g., STA 110) sending this element has executed following receiving the recommended Activity in a DBand Link Measurement Report frame. The method by which the sending STA determines the action is described in FIG. 4 below.

An example of an activity field is shown with Table 2 below, although the scope of the present invention is not limited to this example.

TABLE 2
Activity Field

| Preferred Action Value | Meaning |
|---|---|
| 0 | No change preferred |
| 1 | Change MCS |
| 2 | Decrease transmit power |
| 3 | Increase transmit power |
| 4 | Fast session transfer (FST) |
| 5 | Power conserve mode |
| 6-255 | Reserved |

Reference Timestamp field 240 may include the lower four octets of the TSF timer value sampled at the instant that the MAC received a predetermined signal, for example the PHY-CCA.indication(IDLE) signal which defined in the IEEE 802.11ad standard and/or the WGA standard, that corresponds to the end of the reception of the a data unit that was used to generate the feedback information contained in the Link Measurement Report frame.

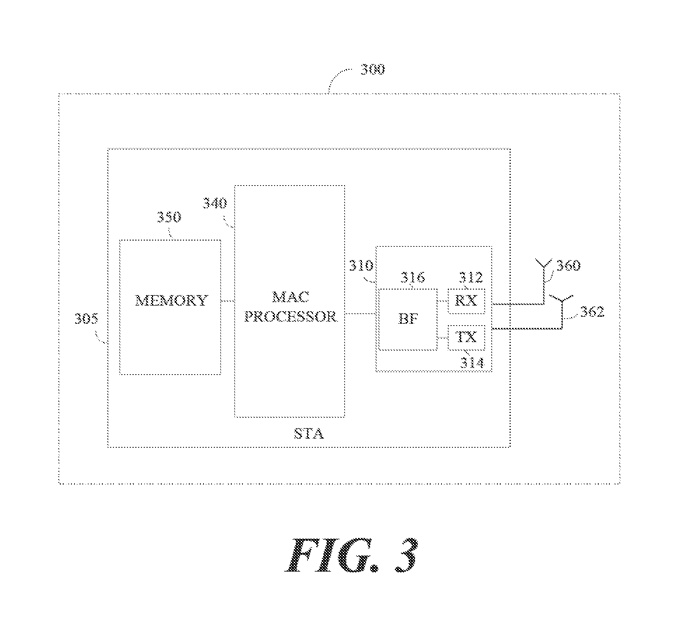

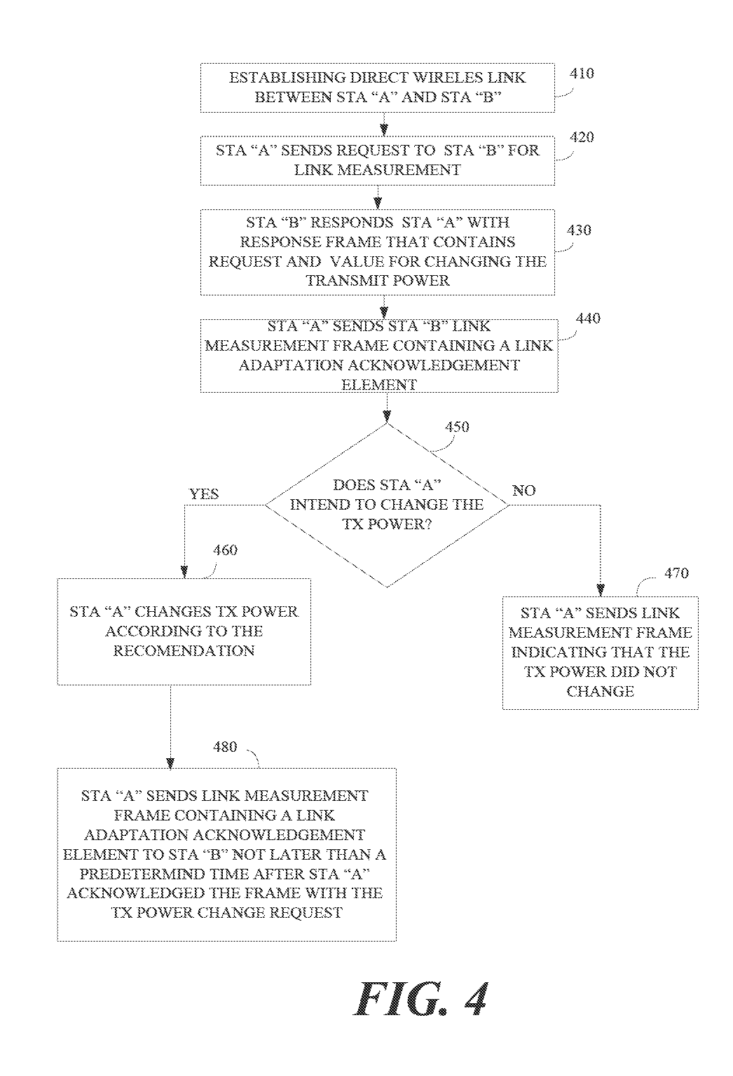

Turning to FIG. 3 a schematic illustration of a system 300 including a station 305 of a wireless communication network according to exemplary embodiments of the present invention is shown. According to embodiments of the present invention, system 300 may include a laptop computer, a desktop computer, a tablet computer, a docking station, a network interface card, a mobile device, a handheld device, a smart phone or the like.

Station 305 may be a wireless communication device that is capable of operating, for example, as: a wireless network controller, an access point, a piconet controller (PNC), a station, a multiband station, a source and/or destination DBand station, an initiator, a responder or the like.

According to some exemplary embodiments of the invention station 305 may include for example, a radio 310. Radio 310 may be operably coupled to two or more antennas. For example radio 310 may operably couple to antennas 360 and 362. Radio 310 may include at least a receiver (RX) 312, a transmitter (TX) 314 and a beamforming (BF) controller 316, although the scope of the present invention is not limited in this respect.

Furthermore, according to some embodiments of the invention, radio 310 may operate on the DBand for example, 60 GHz frequency band. Station 305 may further include a MAC processor 340 and a memory 350. MAC processor 340 may include a station management entity (SME) module 345. MAC processor 340 may operate a MAC protocol according to IEEE 802.11TAGad and/or IEEE 802.15.3c and or WirelessHD™ and/or ECMA-387 and/or ISO/IEC 13156:2009 and/or Bluetooth™ and/or WGA specification, if desired.

Methods according to an embodiment of the present invention, including, for example, calculating link measurement values and operating TPC, may be performed all, or in part, by MAC processor 340.

Memory 350 may include one or more of volatile memory, non-volatile memory, removable or non-removable memory, erasable or non-erasable memory, writeable or re-writeable memory, and the like. For example, memory 350 may include one or more random-access memory (RAM), dynamic RAM (DRAM), Double-Data-Rate DRAM (DDR-DRAM), synchronous DRAM (SDRAM), static RAM (SRAM), read-only memory (ROM), programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like.

In some exemplary embodiments, antennas 360 and 362 may include, for example, phase array antennas, an internal and/or external RF antenna, a dipole antenna, a monopole antenna, an omni-directional antenna, an end fed antenna, a circularly polarized antenna, a micro-strip antenna, a diversity antenna, or other type of antenna suitable for transmitting and/or receiving wireless communication signals, blocks, frames, transmission streams, packets, messages and/or data, although the scope of the present invention is not limited to these examples.

In some exemplary embodiments of the invention, BF controller 316 may include a multiple-input-multiple-output (MIMO) controller and/or a beamformer processor, if desired.

In operation transmitter 314 may transmit over a direct wireless link 125 at a particular transmit power to a receiving station. MAC processor 340 may send a request for a link measurement of said direct wireless link to the receiving station. MAC processor 340 may receive a report frame with an indication and/or request to decrease or to increase the transmit power of the receiving station based on the link measurement. If MAC processor 340 may execute the request no later than a predefined time interval then MAC processor 340 may send a link adaptation acknowledgment frame with an indication to decrease or increase the transmit power based on said link measurement.

Furthermore, MAC processor 340 may not send the link adaptation acknowledgment when executing the request after the predefined time interval. MAC processor 340 may send a link adaptation acknowledgment with an indication that transmit power is not decreased when executing the request no later than a predefined time interval and not decreasing the transmit power.

Turning to FIG. 4, a flow chart of a method of controlling a transmitting power of a station, according to exemplary embodiments of the invention is shown. For example, the method may be executed by a MAC processor e.g., MAC processor 340 from, and/or by executing instructions stored in memory 350, if desired.

According to exemplary embodiments of the present invention, the method of controlling the power of a station is done when a controlled station is in a direct wireless link communication (e.g., direct peer to peer wireless communication) with a second station. The method may start by establishing a direct wireless link between a first station (e.g., source DBand station 110) to a second station (e.g., Destination DBand station 130) as is shown by text box 410. For example, the wireless direct link may be at a 60 GHz frequency band (e.g., DBand). Hereinafter, the first station is depicted as STA “A” and/or as a sending station and the second station is depicted as STA “B” and/or a receiving station, although the scope of the present invention is not limited to this example.

The method may continue by sending a request message from STA “A” (e.g., source DBand station 110) to STA “B” (e.g., Destination DBand station 130) for link measurement (text box 420). The receiving station (e.g., Destination DBand station Destination DBand station 130) may perform a link measurement and may respond to the sending station (e.g., source DBand station 110) with a response frame containing a value, which may be used for changing the transmit power of the sending station (e.g., source DBand station 110) as is shown in text box 430. The sending station may send a frame that contains an Acknowledgment information element (e.g., Acknowledgment information element 200) in return (text box 440). According to one example embodiment, the value for use in changing the transmit power may be included at the Activity filed of the Acknowledgment information element 200, if desired.

For example, if the link measurement response indicates that the transmit power should be increased and/or decreased, the receiving station may set the desired value in the activity field. For example, in order to decrease the transmit power, the receiving station (e.g., Destination DBand station 130) may set the activity field (e.g., activity field 230 as shown with Table 2) with the value 2 or another suitable value. On the other hand, the request may be to increase the transmit power. In this case, the activity field (e.g., activity field 230 as shown with Table 2) may be set with the value 3. It should be understood that the response frame may also be referred by the sending station as a request to preform TPC on the receiving station, although the scope of the present invention is not limited in this respect.

According to this exemplary embodiment of the invention, the sending station (e.g., source DBand station 110) may have a predetermined time period to accept and/or refuse the TPC request from the receiving station (e.g., Destination DBand station 130). For example, the sending station (e.g., source DBand station 110) may decide whether or not to execute the request to change the transmit power (diamond 450). The sending station may decide to execute the request to change the transmit power no later than a timeout value since the sending station is sending acknowledgment (ACK) to the receiving station. If the sending station decides to execute the request to change the transmit power then, the sending station may change the transmit power according to the recommendation (text box 460) and send a link measurement frame containing Acknowledgment information element (e.g., Acknowledgment information element 200) no late than a predetermined time after sending the ACK frame (text block 480).

Otherwise, the sending station may not decrease or increase the transmit power and may send the DBand link adaptation ACK element with the activity field value, which indicates that the transmit power has not been changed (e.g., neither increased nor decreased), although the scope of the present invention is not limited in this respect (text box 470).

In some embodiments of the invention, a DBand STA may use at least one of, and/or both, the Link Measurement procedure and the DBand Link Margin element to perform the TPC, although embodiments of the present invention are not limited to this example.

Furthermore, the DBand STA which receives a Link Measurement Report frame containing a DBand Link Margin element, which indicates Increase or Decrease Transmit power, may behave according to the following rules:

If the DBand STA intends to implement the recommendation indicated in the Activity field of the Link Measurement Report, the DBand station may implement the change and may send a Link Measurement Report frame containing a DBand Link Adaptation Acknowledgement element no later than a desired time, for example, 2*aDBandPPDUMaxTime, after the DBand station acknowledged the reception of the Link Measurement Report. The Activity field of the DBand Link Adaptation Acknowledgement element may be set to be equal to the Activity field in the received DB Link Margin sub element, if desired.

If the DBand STA may not implement the recommendation indicated in the Activity field of the Link Measurement Report, the DBand STA may send the Link Measurement report frame containing a DBand Link Adaptation Acknowledgement element no later than a predefined time, for example, 2*aDBandPPDUMaxTime, after the DBand STA acknowledges the reception of the Link Measurement Report. The Activity field of the DBand Link Adaptation Acknowledgement element may be set to 0, indicating that the STA prefers not to change transmit power.

A DBand STA may not include the DBand Link Adaptation Acknowledgement element in a Link Measurement Report unless it is in response to a Link Measurement Report with Activity field set to increase or decrease transmit power.

The DBand Link Margin sub-element may include the fields as shown in FIG. 2. The DBand Link Margin sub-element is presented in the Optional sub-elements field if the link measurements are performed in related to the DBand PHY, if desired.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

1. (canceled)

2. An apparatus including a processor to cause a wireless station to:
process a first link measurement report frame received at the wireless station, the first link measurement report frame including a link margin element, which indicates an increase or decrease of a transmit power;
transmit an acknowledgment of a reception of the first link measurement report frame; and
transmit a second link measurement report frame including a link adaptation acknowledgement element no later than a predefined time period after the acknowledgment of the reception of the first link measurement report frame, the link adaptation acknowledgement element including a reference timestamp field, the reference timestamp field including four lower octets of a timer value sampled at reception of a signal corresponding to an end of reception of a Protocol Data Unit (PPDU) used to generate feedback information in the second link measurement report frame.

3. The apparatus of claim 2, wherein said first link measurement report frame includes an activity field to indicate a recommendation of the increase or decrease of the transmit power.

4. The apparatus of claim 3, wherein the processor is to select to implement the recommendation, and to set an activity field of the link adaptation acknowledgement element to a value of the activity field of said first link measurement report frame.

5. The apparatus of claim 3, wherein the processor is to select not to implement the recommendation, and to set an activity field of the link adaptation acknowledgement element to a value to indicate that the wireless station is not to change the transmit power.

6. The apparatus of claim 5, wherein said value is zero.

7. The apparatus of claim 2, wherein the predefined time period is two times a Physical Layer Convergence Protocol (PLCP) Protocol Data Unit (PPDU) Maximal time (PPDUMaxTime).

8. The apparatus of claim 2, wherein said second link measurement report frame is in response to said first link measurement report frame.

9. The apparatus of claim 2, wherein the wireless station is a millimeterWave (mmWave) station.

10. The apparatus of claim 2 including one or more antennas, a receiver to receive the first link measurement report frame, a transmitter to transmit the acknowledgement and the second link measurement report frame, and a memory.

11. An apparatus including a processor to cause a wireless station to:
transmit a first link measurement report frame including a link margin element, which indicates an increase or decrease of a transmit power;
process an acknowledgment of a reception of the first link measurement report frame; and
process a reception of a second link measurement report frame including a link adaptation acknowledgement element no later than a predefined time period after the acknowledgment of the reception of the first link measurement report frame, the link adaptation acknowledgement element including a reference timestamp field, the reference timestamp field including four lower octets of a timer value sampled at reception of a signal corresponding to an end of reception of a Protocol Data Unit (PPDU) used to generate feedback information in the second link measurement report frame.

12. The apparatus of claim 11, wherein said first link measurement report frame includes an activity field to indicate a recommendation of the increase or decrease of the transmit power.

13. The apparatus of claim 12, wherein an activity field of the link adaptation acknowledgement element has a value of the activity field of said first link measurement report frame.

14. The apparatus of claim 11, wherein an activity field of the link adaptation acknowledgement element has a value to indicate no change in the transmit power.

15. The apparatus of claim 14, wherein said value is zero.

16. The apparatus of claim 11, wherein the predefined time period is two times a Physical Layer Convergence Protocol (PLCP) Protocol Data Unit (PPDU) Maximal time (PPDUMaxTime).

17. The apparatus of claim 11, wherein said second link measurement report frame is in response to said first link measurement report frame.

18. The apparatus of claim 11, wherein the wireless station is a millimeterWave (mmWave) station.

19. The apparatus of claim 11 including one or more antennas, a transmitter to transmit the first link measurement report frame, a receiver to receive the acknowledgement and the second link measurement report frame, and a memory.

20. A product including one or more tangible computer-readable non-transitory storage media comprising computer-executable instructions operable to, when executed by at least one computer processor, enable the at least one computer processor to implement a method at a first wireless station, the method comprising:
communicating a first link measurement report frame with a second wireless station, the first link measurement report frame including a link margin element, which indicates an increase or decrease of a transmit power;
communicating with the second wireless station an acknowledgment of a reception of the first link measurement report frame; and
communicating with the second wireless station a second link measurement report frame including a link adaptation acknowledgement element no later than a predefined time period after the acknowledgment of the reception of the first link measurement report frame, the link adaptation acknowledgement element including a reference timestamp field, the reference timestamp field including four lower octets of a timer value sampled at reception of a signal corresponding to an end of reception of a Protocol Data Unit (PPDU) used to generate feedback information in the second link measurement report frame.

21. The product of claim 20, wherein said first link measurement report frame includes an activity field to indicate a recommendation of the increase or decrease of the transmit power.

22. The product of claim 21, wherein the method comprises receiving the first link measurement report frame, selecting to implement the recommendation, setting an activity field of the link adaptation acknowledgement element to a value of the activity field of said first link measurement report frame, and transmitting the second link measurement report frame.

23. The product of claim 21, wherein the method comprises receiving the first link measurement report frame, selecting not to implement the recommendation, setting an activity field of the link adaptation acknowledgement element to a value to indicate that the wireless station is not to change the transmit power, and transmitting the second link measurement report frame.

24. The product of claim 23, wherein said value is zero.

25. The product of claim 20, wherein the method comprises transmitting the first link measurement report frame, and receiving the second link measurement report frame.

26. The product of claim 20, wherein the predefined time period is two times a Physical Layer Convergence Protocol (PLCP) Protocol Data Unit (PPDU) Maximal time (PPDUMaxTime).

27. The product of claim 20, wherein said second link measurement report frame is in response to said first link measurement report frame.
